(19) United States
(12) Patent Application Publication
(10) Pub. No.: US 2018/0112648 A1
(43) Pub. Date: Apr. 26, 2018

(54) HYBRID WIND TURBINE FOR POWER OUTPUT IN LOW AND ZERO WIND CONDITIONS

(71) Applicant: James Bond, Dayton, OH (US)

(72) Inventor: James Bond, Dayton, OH (US)

(21) Appl. No.: 15/789,270

(22) Filed: Oct. 20, 2017

Related U.S. Application Data
(60) Provisional application No. 62/410,810, filed on Oct. 20, 2016.

(51) Int. Cl. F03D 9/11; F03D 7/02; F03D 9/00; F03D 9/25; H02K 47/04; H02K 7/18

(52) U.S. Cl. CPC F03D 9/11; F03D 7/0276; F03D 9/007; F03D 1/06; H02K 47/04; H02K 7/1815; H02K 7/1838; F03D 9/255

(57) ABSTRACT

A hybrid wind turbine having comprising photovoltaic cells, an induction generator and batteries, adapted to output power in low wind conditions and stored power in zero wind conditions, with heavy components disposed in the base of the tower to facilitate maintenance operations, with an alternative reciprocating liquid-nitrogen engine for assisting with drive torque in low wind conditions.

### BACKGROUND OF THE INVENTION

### Field of the Invention

This invention relates to windmills, and more particularly relates to wind mills having turbines for power generation.

### Description of the Related Art

Wind turbines for power generation are well-known in the art, having passed through several generations of technology, each improving upon previous technologies. Efforts to reduce dependence upon fossil fuels has led to increasing demand for efficient and relatively rugged wind turbines which provide substantial electric power in areas where the prevailing winds are sufficient to effect operation of the windmills/turbines over substantial periods of time.

The prior art teaches wind turbines fabricated with a plurality of rotors which rotate axially about a horizontal axis, converting the mechanical rotation of the rotors or blades to electrical energy for use in an external circuit using an induction motory and which often are used to distribute power over a distributed power grid or system. Slow and fast shafts are known in the art, with some wind turbines making use of gearboxes to increase the rotations per minute of a secondary shaft driving an induction generator. All of these embodiments of the art, however, suffer from a general inefficiency inasmuch as they do not output stored electricity when the ambient air is still. Only when wind speeds increase to a sufficient speed to overcome the force of friction between the rotors and the drive shaft do the rotors begin spinning and generating electricity. Sometimes a wind vane is used for determining whether a wind velocity has exceeded a threshold sufficient to spin the rotators.

It would be desireable to have a wind turbine system whic output or distributed electricity in low wind conditions. Such a system would, inter alia, prevent residences and other end users in a distributed system from having to install and maintain backup power storage systems for use in low wind conditions. It would also be desireable to position some of the heavier components traditionally housed within a nacelle in the base of (which elevates the nacelle) such that the center of gravity of the wind turbine system was lowered to reduce the potential for toppling of the tower in high wind conditions and to facilitate more convenient maintanace operations. It would also be desireable to incorporate a liquid nitrogen engine into some embodiments for power generation use as needed, including in exigent situations.

It is desirable, and an object of the present invention, to provide an apparatus, system and method of generating electricity using a hybrid wind turbine which continues outputting stored electricity when the ambient air is still or in low wind conditions.

### SUMMARY OF THE INVENTION

From the foregoing discussion, it should be apparent that a need exists for an apparatus, system and method of generating electricity in low wind conditions using a hybrid wind turbine. Beneficially, such an apparatus, system and method would overcome many of the difficulties with prior art by providing a means of outputting electricity using hybrid wind turbine in low wind conditions.

The present invention has been developed in response to the present state of the art, and in particular, in response to the safety problems and needs in the art that have not yet been fully solved by currently available aparati, systems and methods. Accordingly, the present invention has been developed to provide a hybrid wind turbine, the wind turbine comprising: a plurality of rotors adapted to rotate axially about a horizontal axis in windy conditions, the rotars affixed to a hub having a slip ring; a nacelle mounted atop a cylindrical tower, the nacelle housing: a drive shaft affixed to a center of gravity of the rotors, the drive shaft adapted to spin an induction motor to generate alternating current; a flex coupling; a gearbox; a drive motor configured to rotate the drive shaft when wind conditions are calm; a plurality of photovoltaic cells affixed to one or more of an exterior surface of the nacelle and an exterior surface of the tower; and a plurality of batteries for storing a charge output from the induction motor.

A portion of the direct current generated by the induction motor may be diverted to the batteries. The batteries may be disposed at a base of the tower and affixed to the tower to reduce a center of gravity of the wind turbine. The liquid nitrogen engine 242 may be positioned within the nacelle 240 as shown or alternatively may be positioned in a base of the tower 104 and affixed to an interior surface of the tower 104 to reduce a center of gravity of the wind turbine and easily facilitate maintenance operations as shown at 238.

The drive shaft may comprise one of a slow drive shaft 204 and a fast drive shaft.

The drive motor may be configured, in some embodiments, to apply only the torque to the drive shaft necessary to overcome a coefficient of friction between the rotors 102 and the drive shaft in low wind conditions.

The batteries may be trickle charged by the induction motor. The wind turbine may further comprise a manual override switch as a base of a tower adapted to disengage the induction motor from the blades.

The wind turbine, in some embodiments, may further comprise an external fuel tank at the base of the tower. The wind turbine may also further comprise a plurality of photovoltaic stations in close proximity to the tower.

A second hybrid wind turbine is provided, the wind turbine comprising: a plurality of rotors adapted to rotate axially about a horizontal axis in windy conditions, the rotars affixed to a hub having a slip ring; a nacelle mounted atop a cylindrical tower, the nacelle housing: a drive shaft affixed to a center of gravity of the rotors, the drive shaft adapted to spin an induction motor to generate alternating current; a flex coupling; a gearbox; a drive motor configured to rotate the drive shaft when wind conditions are calm; a plurality of photovoltaic cells affixed to one or more of an exterior surface of the nacelle and an exterior surface of the tower; and a plurality of batteries for storing a charge output from the induction motor, wherein the batteries are charged by one or more of the induction generator and the photovoltaic cells.

A portion of direct current generated by the induction motor may be diverted to the batteries. The batteries may be disposed at a base of the tower and affixed to the tower to reduce a center of gravity of the wind turbine.

The batteries may be configured to apply only the torque to the drive shaft necessary to overcome a coefficient of friction between the rotors and the drive shaft in low wind conditions after the rotars are disengaged from the drive shaft.

The wind turbine may further comprise a manual override switch as a base of a tower adapted to disengage the induction motor from the blades. The wind turbine may further comprise an external fuel tank.

The wind turbine, in alternative embodiments, may further comprise a plurality of photovoltaic stations in close proximity to the tower.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a forward perspective of a hybrid wind turbine in accordance with the present invention;

FIG. 2 illustrates a sectioned side perspective of a hybrid wind turbine in accordance with the present invention;

FIG. 3 illustrates an exploded sectioned side perspective of a generator of a hybrid wind turbine in accordance with the present invention; and

FIG. 4 illustrates the steps of a method for generating power using a hybrid wind turbine in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to convey a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

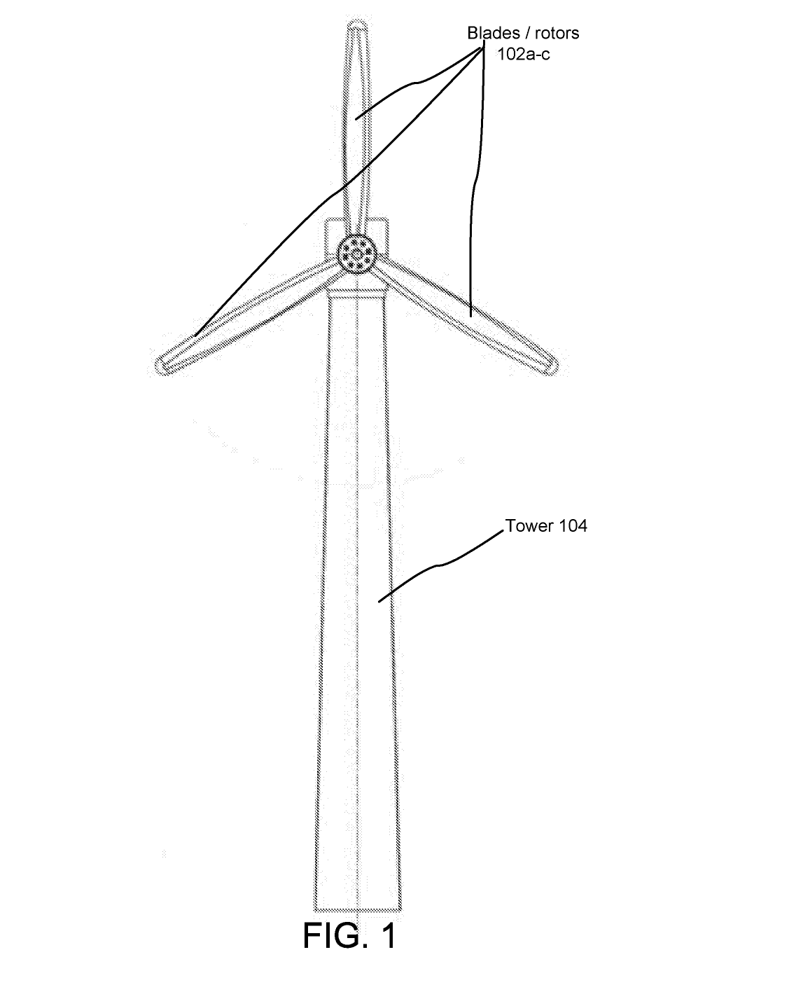

FIG. 1 illustrates a forward perspective of a hybrid wind turbine 100 in accordance with the present invention. The wind turbine 100 comprises a cylindrical tower 104 formed from steel, carbon fiber, fiberglass, aluminum or other means known to those of skill in the art mounted on a cement foundation.

The hybrid wind turbine comprises two or more blades or rotors 102 which rotate axially about a horizontal drive shaft traversing a nacelle 240 having various electric, electromechancial and/or hydraulic components for imparting power producing function to the wind turbine 100.

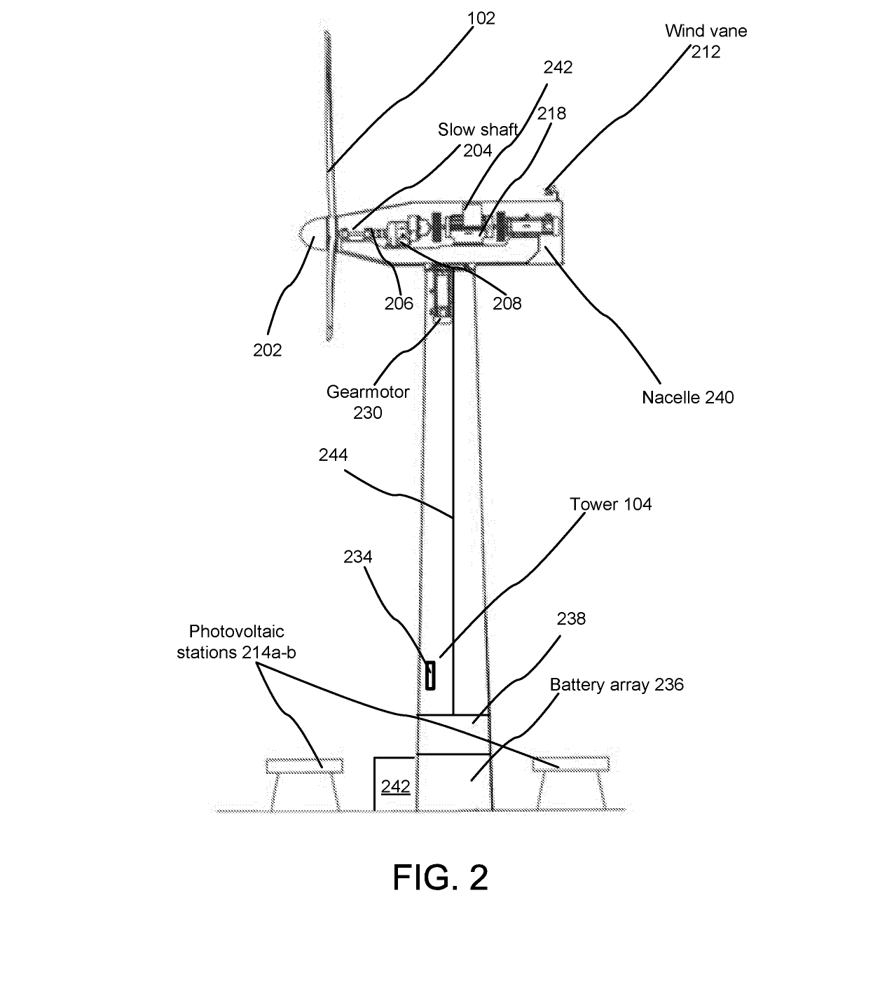

FIG. 2 illustrates a sectioned side perspective of a hybrid wind turbine 200 in accordance with the present invention.

As shown, the hub 202, including a slip ring, is affixed at one end to the rotors 102. At another end, a slow drive shaft 204 affixed to the hub 202 may be affixed to an induction motor and/or a generator and/or a flex coupling 206. The generator may be incorporated into the body of the turbine 200 within the nacelle 240 or disposed within or below the tower 104 at ground level or near ground level and mechanically interconnected with the rotars 102 using a shaft 244, U-joints and/or bevel gears as known to those of skill in the art. In those embodiments comprising a shaft 244, many of the components shown housed within the nacelle 240 are instead housed within the base of the tower 104 to reduce the center of gravity and facilitate more convenient maintenance operations at the base of the tower 104.

In various embodiments, element 242 consists of a liquid nitrogen engine, an induction generator, a reciprocating fuel-combustion engine.

The tower 104 may comprise a manual override switch 234 which allows an operator to manually change the operation of the hybrid wind turbine 200 from rotationall-powered or axially-powered generation to DC motor 216 generation. In some embodiments, the manual override switch 234 has more than two settings, including settings adapted to configure the wind turbine assembly 200 to output power directly from batteries 236 stored within the tower 104 (which may be charged by the photovoltaic stations 214), an embodiment in which stored power in the batteries is used to rotate or induce a current, or to partially torque, a drive shaft within a generator (304 shown below), or to power on a liquid nitrogen engine 238 disposed and affixed within the base of the tower 104. A liquid nitrogren engine 238 is known to those of skill in the art, and comprises a heat exchanger and pressurized gas piston. An external tank 242 for housing liquid nitrogen to fuel the liquid nitrogen engine 238 may be affixed to a base of the tower 104.

The batteries 236 may be trickle-charged at night to by induction generator 304.

In some embodiments, manual activation of the override switch 234 results in disconnection of the hub 202 and/or rotars 102 from the slow drive shaft 204 at a clutch or transmission within the nacelle 240. The rotars 102 may be coating with solar paint or layered with photovoltaic cells.

In various embodiments, the wind turbine 200 is configured to automatically switch to power generation using the DC motor, powered by batteries 236 charged by, inter alia, the photovoltatic cells 214, in reponse to the direction sensor 212 measuring the ambient wind speed has fallen below a predetermined threshold, which threshold may be between five and ten miles per hour.

In various embodiments, the wind turbine 200 may alternatively be configured to activate a generator disposed near the photovoltaic cells 214 or in the nacelle 240, which generator powers an electric motor.

Ultimately torque applied to the drive shaft 204 may induce a current electromagnetically in a generator 304.

The clutch/brake mechanism 310 may be adapted to, or configured to, engage and disengage the rotors from the slow drive shaft 204 and/or a secondary drive shaft within the nacelle 240 mechanically-interconnecting.

In various embodiments, the DC motor 216 and the generator may be configured to apply only the torque necessary to the drive shaft to overcome a coefficient of friction necessary to keep the drive shaft spinning with force from the rotos in low wind conditions.

In various embodiments, the generator is disposed at the top of the tower, at the bottom of the tower, or outside the tower. The generator may be powered by a plurality of batteries charged by the photovoltaic cells 214a-b and/or trickle charged by power generated during operation in zero wind, low wind, or high wind conditions.

The plurality of batteries, or battery array, may include batteries connected in parallel or in series, which are used to power, or partially power, the DC motor which powers the induction motor. This added power may overcome friction inherent in the system in low wind conditions allowing the rotors 102 to spin in low wind conditions that would not typically be strong enough to overcome friction, or the added power may be used to entire power the DC motor and/or induction motor. The batteries 236 may be dispoed beneath the photovoltaic cells 214, within the tower, in separate housing units. The batteries 236 may be trickle charged with power diverted from the induction motor and/or with the photovoltaic cells 214.

The induction motor, or induction generator 304, is included within the nacelle 240 of the apparatus 200. The induction generator 304 operates on the principle of a rotating magnetic field. An induction generator or asynchronous generator is a type of electrical generator that uses the principles of induction motors to produce power. Induction generators operate by mechanically turning their rotors faster than synchronous speed. A regular asynchronous motor usually can be used as a generator, without any internal modifications. Induction generators are useful in applications such as mini hydro power plants, wind turbines, or in reducing high-pressure gas streams to lower pressure, because they can recover energy with relatively simple controls. The induction generator 304 draws its excitation power from a DC motor and/or generator within the wind turbine 200.

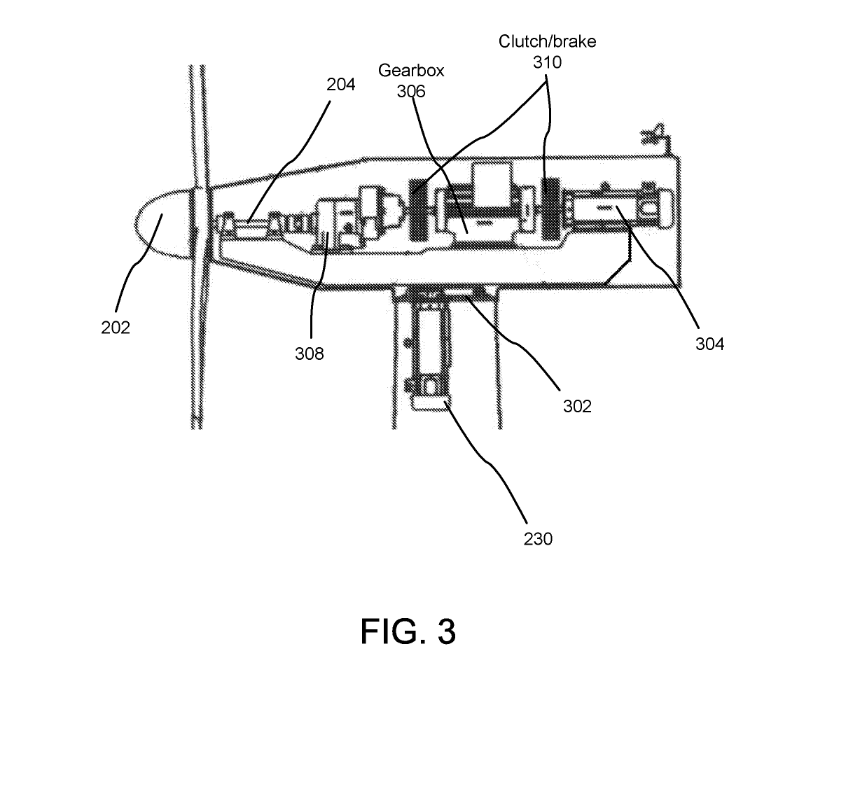

FIG. 3 illustrates a sectioned side perspective of a generator of a hybrid wind turbine 300 in accordance with the present invention.

A sample assembly which may be incorporated into the hybrid wind turbine is shown. In the shown embodiment, the generator 304 is powered by a plurality of batteries 236 connected in series or in parrallel. In other embodiments, the generator 304 comprises a reciprocating fuel combustion engine for overcoming friction in low wind conditions and/or generating power for the distributed power system.

The wind turbine 300 comprises a slip bearing 302, or slip ring, positioned between the nacelle 240 and the tower 104 which facilitates axialy rotation of the nacelle 240 about the tower 104 with reduced friction.

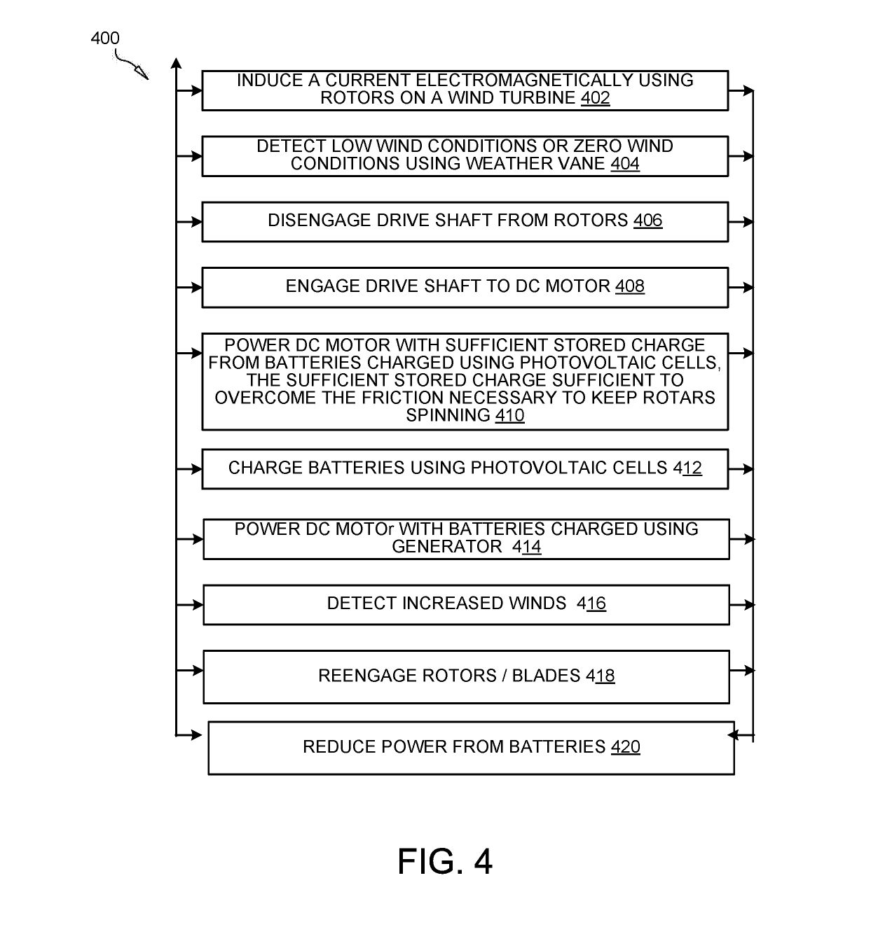

FIG. 4 illustrates the steps of a method for generating power using a hybrid wind turbine 400 in accordance with the present invention.

As shown in the flow chart of the method 400, the drive shaft 204 may optionally be disengaged from the rotars 102 in low wind conditions and the induction motor 304 powered with the batteries 236. Alternatively, the rotars 102 may remain connected mechanically via the drive shaft to the induction generator and a DC motor powered with the batteries 236 with sufficient charge to add sufficient torque to the drive shaft 204 or a secondary drive shaft to over friction and keep the induction generator 304 outputting induced power.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A hybrid wind turbine, the wind turbine comprising:
a plurality of rotors adapted to rotate axially about a horizontal axis in windy conditions, the rotars affixed to a hub having a slip ring;
a nacelle mounted atop a cylindrical tower, the nacelle housing:
a slow drive shaft affixed to a center of gravity of the rotars, the drive shaft adapted to spin an induction generator to generate alternating current;
a flex coupling;
a gearbox;
a drive motor configured to rotate the drive shaft in low wind conditions;
a plurality of photovoltaic cells affixed to one or more of an exterior surface of the nacelle and an exterior surface of the tower; and
a plurality of batteries for storing a charge output from one of the induction motor and the photovoltaic cells.

2. The wind turbine of claim 1, wherein a portion of direct current generated by the induction motor is diverted to the batteries and a remaining portion distributed over a distributed power system.

3. The wind turbine of claim 1, wherein a stored charge in the batteries is used to at least partially power a DC motor in the nacelle, the DC motor applying torque to rotate a drive shaft within the induction generator in low wind conditions.

4. The wind turbine of claim 1, wherein the batteries are disposed at a base of the tower and affixed to the tower to reduce a center of gravity of the wind turbine and facilitate maintainance operations.

5. The wind turbine of claim 1, wherein a liquid nitrogen engine is positioned in a nacelle to apply torque to a drive shaft in low wind conditions.

6. The wind turbine of claim 1, wherein a liquid nitrogen engine is positioned in a base of the tower and affixed to an interior surface of the tower to reduce a center of gravity of the wind turbine and easily facilitate maintenance operations, the liquid nitrogen engine outputting power to a DC motor in the nacelle.

7. The wind turbine of claim 1, wherein the drive shaft comprises one of a slow drive shaft and a fast drive shaft.

8. The wind turbine of claim 1, wherein the DC motor is adapted to apply only the torque to the drive shaft necessary to overcome a coefficient of friction between the rotors and the drive shaft in low wind conditions.

9. The wind turbine of claim 1, further comprising a manual override switch as a base of a tower adapted to disengage the induction motor from the rotars.

10. The wind turbine of claim 1, further comprising an external fuel tank at the base of the tower for storing liquid nitrogen.

11. The wind turbine of claim 1, further comprising a plurality of photovoltaic stations in close proximity to the tower adapted to charge the batteries and output a current to a distributed power system.

12. A hybrid wind turbine, the wind turbine comprising:
a plurality of rotars adapted to rotate axially about a horizontal axis in windy conditions, the rotars affixed to a hub having a slip ring;
a nacelle mounted atop a cylindrical tower, the nacelle housing:
a drive shaft affixed to a center of gravity of the rotors, the drive shaft adapted to spin an induction motor to generate alternating current;
a flex coupling;
a gearbox;
a reciprocating fuel combustion engine configured to rotate the induction motor when wind conditions are calm;
a drive motor configured to rotate the drive shaft when wind conditions are calm;
a plurality of photovoltaic cells affixed to one or more of an exterior surface of the nacelle and an exterior surface of the tower; and
a plurality of batteries for storing a charge output from the induction motor, wherein the batteries are charged by one or more of the induction generator and the photovoltaic cells.

13. The wind turbine of claim 1, wherein a portion of direct current generated by the induction motor is diverted to the batteries.

14. The wind turbine of claim 1, wherein the batteries are disposed at a base of the tower and affixed to the tower to reduce a center of gravity of the wind turbine.

15. The wind turbine of claim 1, further comprising a manual override switch as a base of a tower adapted to disengage the induction motor from the blades.

16. The wind turbine of claim 1, further comprising a plurality of photovoltaic stations in close proximity to the tower.

17. The wind turbine of claim 1, where an exterior surface of the tower is enveloped with photovoltaic cells.

18. A hybrid wind turbine, the wind turbine comprising:
a plurality of rotars adapted to rotate axially about a horizontal axis in windy conditions, the rotars affixed to a hub having a slip ring;
a nacelle mounted atop a cylindrical tower, the nacelle housing:
a drive shaft affixed to a center of gravity of the rotors, the drive shaft adapted to spin an induction motor to generate alternating current;
a gearbox;
a plurality of photovoltaic cells affixed to one or more of an exterior surface of the nacelle and an exterior surface of the tower;
a downward shaft interconnecting the gearbox with an induction generator;
a drive motor configured to rotate the drive shaft when wind conditions are calm;
the induction generator disposed in a base of the tower to lower a center of gravity and facilitate more convenienent maintenance operations;
a plurality of batteries for storing a charge output from the induction motor, wherein the batteries are charged by one or more of the induction generator and the photovoltaic cells.
